(19) United States
(12) Patent Application Publication
(10) Pub. No.: US 2010/0268481 A1
(43) Pub. Date: Oct. 21, 2010

(54) Monitoring system and method for electronic device

(75) Inventor: Mario John Dominic Lee, Santa Clara, CA (US)

Correspondence Address: Altis Law Group, Inc.;ATTN: Steven Reiss, 288 SOUTH MAYO AVENUE, CITY OF INDUSTRY, CA, 91789, US

(73) Assignee: HON HAI Precision Industry CO., LTD., Tu-Cheng City (TW)

(21) Appl. No.: 12/456,059

(22) Filed: Jun. 11, 2009

(30) Foreign Application Priority Data
Apr. 17, 2009 (CN) 200910301642.4

(51) Int. Cl. G01B 3/52; G01L 7/00

(52) U.S. Cl. 702/34; 702/56

(57) ABSTRACT

A system includes a device, a sensor connected to the device, and a processing module connected to the sensor. The sensor detects shock and vibration of the device and stores the shock and vibration data. The processing module receives the shock and vibration data from the sensor and predicts useful life of the vibrating device.

### BACKGROUND

1. Technical Field

The present disclosure relates to a monitoring system and method for monitoring shock and vibration of an electronic device.

2. Description of Related Art

Traditional thinking about HDD (Hard Disk Drive) failure has been focused on the temperature history of the HDD. Through the Self Monitoring Analysis and Reporting Technology (S.M.A.R.T) protocol standard, things such as HDD temperature, Head Flying Height, Spin Up Time etc. are recorded. However, it has been found that temperature history by itself is not enough to predict HDD failure. HDD failure has a strong correlation to mechanical environment (vibration and shock) experienced by the HDD. For example, when an HDD fails and is manually replaced, statistics show that neighboring HDD drives have a higher probability of failing soon after. This indicates that vibration and mechanical shock experienced by drives due to replacement of a neighboring drive is an important factor.

Therefore, a monitoring system and method for monitoring shock and vibration of an HDD is desired.

### BRIEF DESCRIPTION OF THE DRAWINGS

FIG. 1 an block diagram of a monitoring system in accordance with an embodiment of the present disclosure.

FIG. 2 is a flow chart of a monitoring method for an electronic device in accordance with an embodiment of the present disclosure.

### DETAILED DESCRIPTION

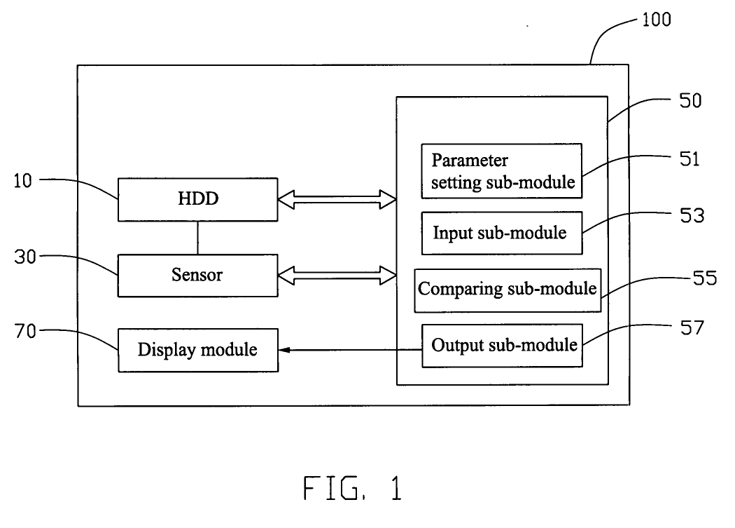

Referring to FIG. 1, an embodiment of a monitoring system 100 includes a HDD 10, a sensor 30, a processing module 50 connected to the HDD 10 and the sensor 30, and a display module 70.

The sensor 30 is attached to the HDD 10, and capable of collecting data of shock and vibration experienced by the HDD 10. In one embodiment, the sensor 30 is a micro electro mechanical (MEM) accelerometer (such as ADX330 accelerometer or LIS302DL accelerometer, etc). The MEM accelerometer can measure the static acceleration of gravity in tilt sensing applications as well as dynamic acceleration resulting from motion, shock, or vibration. In some embodiments, the accelerometer 30 is attached to a tiny PCB (printed circuit board) (not shown), and the PCB is attached to the HDD 10 by using adhesive attach.

The processing module 50 includes a parameter setting sub-module 51, an input sub-module 53, a comparing sub-module 55, and an output sub-module 57. Predetermined parameters can be set using the parameter setting sub-module 51, such as frequency and magnitude of vibration to be recorded, how often to process comparison results etc. The input sub-module 53 is utilized to receive the shock and vibration data from the sensor 30. The comparing sub-module 55 is utilized to compare the collected shock and vibration data with the predetermined parameters. The comparing sub-module 55 may process the results according to the type and history of the HDD 10 to produce a likely remaining life prediction of the HDD 10 at regular intervals or upon receiving a user command according to the pre determined parameters. The output sub-module 57 sends the results to the display module 70 for display.

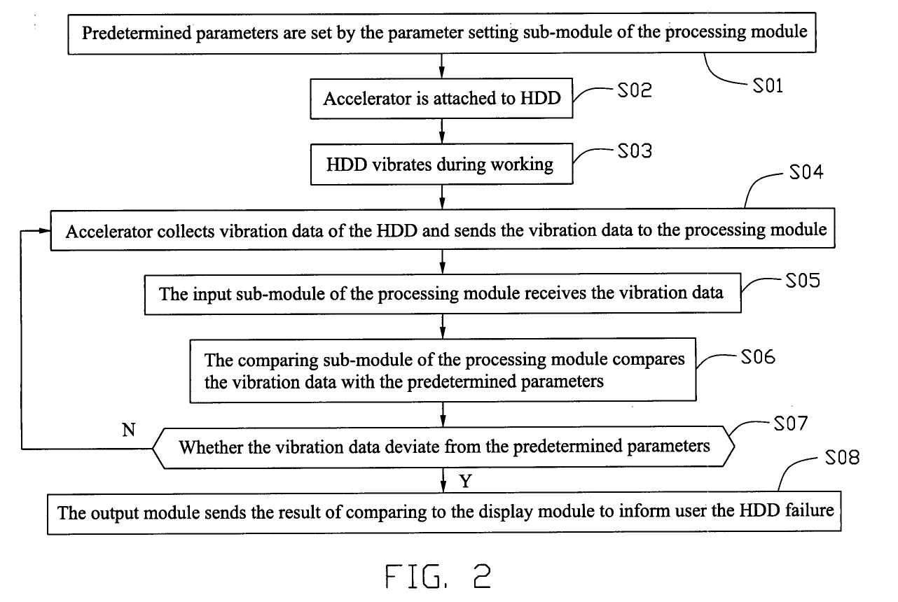

Referring to FIG. 2, an operational sequence, according to one embodiment of the system 100, includes the following blocks.

In block S01, predetermined parameters are set using the parameter setting sub-module 51 of the processing module 50. In block S02, the accelerometer 30 is attached to the HDD 10. In Block S03, if the HDD 10 vibrates during working, and the accelerometer 30 vibrates together with the HDD 10 since it is attached to the HDD 10. In block S04, the accelerometer 30 collects vibration data and sends the vibration data to the processing module 50. In block S05, the input sub-module 53 of the processing module 50 receives the vibration data from the sensor 30. In block S05, the comparing sub-module 55 of the processing module 50 compares the vibration data with the predetermined parameters. In block S07, if the vibration data does not deviate from the predetermined parameters, go to block S04; if the vibration data deviates from the predetermined parameters, go to block S08. In block S08, the output sub-module 57 of the processing module 50 sends the results to the display module 70.

In one embodiment, the predetermined parameters include a maximum period of time which the HDD 10 will endure vibration. The comparing sub-module 55 of the processing module 50 compares the vibration data with the maximum time. If the HDD 10 vibrates for a period of time exceeding the maximum time, an signal is sent that to warn that the HDD 10 is nearing the end of its useful life. It could also trigger an automatic backup.

The monitor system 100 can be used on any hard drive used in server or storage chassis to help better predict potential HDD failure. It can also be used on fans to monitor and potentially better predict fan failure as well in the field.

While the present invention has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and illustrative examples shown and described.

It is also to be understood that the above description and the claims drawn to a method may include some indication in reference to certain steps. However, the indication used is only to be viewed for identification purposes and not as a suggestion as to an order for the steps.

What is claimed is:

1. A system comprising:
a device;
a sensor connected to the device and capable of detecting shock and vibration of the device and storing the shock and vibration data; and
a processing module connected to the sensor and capable of receiving the shock and vibration data from the sensor and predicting a life of the vibrating device.

2. The system of claim 1, wherein the sensor is a micro electro mechanical accelerometer.

3. The system of claim 1, wherein the device is a hard disk drive.

4. The system of claim 1, wherein the device is a fan.

5. The system of claim 1, wherein the processing module comprises a parameter setting module, the parameter setting module stores predetermined parameters.

6. The system of claim 5, wherein the processing module further comprises a comparing module, the comparing module compares the shock and vibration data of the hard disk drive with the predetermined parameters.

7. The system of claim 6, further comprising a display module capable of sending the shock and vibration data and the comparing result to a display.

8. The system of claim 7, wherein the processing module further comprises an input module for receiving the shock and vibrating data and an output module for sending the shock and vibration data and the comparing result to the display module.

9. A method comprising:
attaching an accelerometer to a hard disk drive;
connecting a processing module to the accelerometer;
the accelerometer collecting the shock and vibrating data of the hard disk drive; and
the processing module receiving the shock and vibrating data and predicting an expected life of the hard disk drive.

10. The method of claim 9, further comprising setting predetermined parameters.

11. The method of claim 10, further comprising comparing the shock and vibrating data with the predetermined parameters.

12. The method of claim 11, wherein the predetermined parameters comprises a period of time for which the hard disk drive is expected to endure the vibration.

13. The method of claim 12, further showing a notice of a possible hard disk drive failure on a display module if the shock and vibration data exceeds the value of the period of time.

14. The method of claim 11, further comprising sending the shock and vibration data and the comparing result to a display module.
